(19) United States
(12) Patent Application Publication
(10) Pub. No.: US 2026/0332004 A1
(43) Pub. Date: Oct. 22, 2026

(54) ACTUATOR

(71) Applicant: Fanuc Corporation, Minamitsuru, Yamanashi (JP)

(72) Inventors: Hidetoshi UEMATSU, Minamitsuru-gun, Yamanashi (JP); Koutarou YAMADA, Minamitsuru-gun, Yamanashi (JP)

(73) Assignee: Fanuc Corporation, Minamitsuru, Yamanashi (JP)

(21) Appl. No.: 18/880,764

(22) PCT Filed: Aug. 26, 2022
(86) PCT No.: PCT/JP2022/032275

§ 371 Date: Jan. 2, 2025

(51) Int. Cl. H02K 11/215; H02K 1/12; H02K 1/27

(52) U.S. Cl. CPC H02K 11/215; H02K 1/12; H02K 1/27

(57) ABSTRACT

An actuator equipped with a motor and an encoder unit includes: a first structure portion that determines the relative angles between a plurality of coils of a stator core and a housing; a second structure portion that determines the relative angles between the magnetic poles of a rotor core and the fixed reference region of a rotating disk provided on a shaft; a third structure portion that determines the relative angle between the shaft and the rotating disk; and a fourth structure portion that determines the relative angle between the housing and a detection portion.

### CROSS REFERENCE TO RELATED APPLICATIONS

This is the U.S. National Phase application of PCT/JP 2022/032275, filed Aug. 26, 2022, the disclosure of this application being incorporated herein by reference in its entirety for all purposes.

### FIELD OF THE INVENTION

The present disclosure relates to an actuator.

### BACKGROUND OF THE INVENTION

In an actuator comprising an encoder and a motor, such as a servo motor, it is necessary to attach the rotary disk of the encoder to the hollow shaft of the motor (for example, Japanese Unexamined Patent Publication (Kokai) No. 2017-203645).

### PATENT LITERATURE

PTL 1: Japanese Unexamined Patent Publication (Kokai) No. 2017-203645

### SUMMARY OF THE INVENTION

The relative angle between the rotary disk and the rotor of the motor is determined in accordance with the positional relationship between the rotary disk and the hollow shaft.

Since the housing of the stator and the stator core of a motor are generally assembled by shrink fitting between cylindrical surfaces thereof, the relative angle between the housing and each phase of the coil wound around the stator core is not fixed.

Since the hollow shaft and the rotor core of the rotor of the motor are generally assembled by shrink fitting between cylindrical surfaces thereof, the relative angle between the fixed part of the rotary disk of the encoder attached to the hollow shaft of the rotor and the magnetic pole of the magnet mounted on the rotor core is also not fixed.

Thus, when installing the rotary disk, it is not possible to adjust the angle between the motor coil and the magnetic poles as viewed from the Z phase (the angle of the Z phase when the coil and magnetic poles are aligned in the specified positions).

Accordingly, accurate adjustment of the Z-phase angle using a method for determining the angle of the rotary disk by DC excitation is desired.

According to a first aspect of the present disclosure, there is provided an actuator comprising a stator, wherein the stator includes a housing, and a stator core which is affixed in the housing and around which a plurality of coils are wound, the actuator further comprising a rotor which is arranged so as to face the stator, wherein the rotor includes a rotor core for forming a plurality of magnetic poles, and a shaft which is coupled to the rotor core, the actuator further comprising an encoder unit, wherein the encoder unit includes a rotary disk which is connected to the shaft, a detection unit for detecting rotation of the rotary disk, and a fixed part which is affixed in the housing, the actuator further comprising a first structure for determining a relative angle between the plurality of coils of the stator core and the housing, a second structure for determining a relative angle between the magnetic poles of the rotor core and a fixed reference position of the rotary disk provided on the shaft, a third structure for determining a relative angle between the shaft and the rotary disk, and a fourth structure for determining and adjusting a relative angle between the housing and the detection unit.

The objects, features, and advantages of the present disclosure will become more apparent from the following description of the embodiments in conjunction with the accompanying drawings.

### BRIEF DESCRIPTION OF DRAWINGS

FIG. 1 is an axial cross-sectional view of an actuator according to a first embodiment.

FIG. 2A is a radial cross-sectional view of a housing.

FIG. 2B is a radial cross-sectional view of a stator core.

FIG. 3 is a perspective view showing a hollow shaft and a rotary disk.

FIG. 4 is an axial cross-sectional view of an actuator detailing a modification example of a second structure.

FIG. 5 is another axial cross-sectional view of the actuator shown in FIG. 1.

FIG. 6 is an axial cross-sectional view of an actuator according to another embodiment.

FIG. 7 is a front view of an encoder fixed part.

FIG. 8A is a partial axial cross-sectional view of an actuator according to another embodiment.

FIG. 8B is a radial cross-sectional view of the actuator shown in FIG. 7A.

### DETAILED DESCRIPTION OF EMBODIMENTS OF THE INVENTION

The embodiments of the present disclosure will be described below with reference to the accompanying drawings. In the drawings, corresponding constituent elements have been assigned common reference signs.

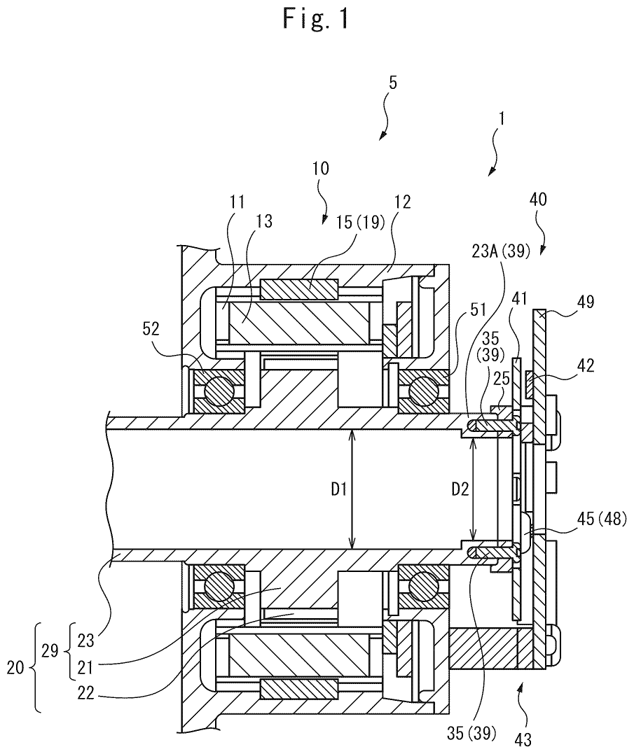

FIG. 1 is an axial cross-sectional view of an actuator based on a first embodiment. The actuator 1 shown in FIG. 1 primarily comprises a motor 5, for example a servo motor, which is composed of a stator 10 and a rotor 20, and an encoder 40 connected to the motor 5. The encoder 40, which comprises a rotary disk 41, is, for example, an incremental encoder, and outputs A-phase, B-phase, and Z-phase signals. The encoder 40 may be an optical encoder or a magnetic encoder.

The stator 10 comprises a stator core 11 arranged in a housing 12. The stator core 11 comprises a plurality of coils 13 arranged around the central axis of the motor 5. The rotor 20 is rotatably arranged inside the stator core 11. The rotor 20 comprises a rotor core 21 having a plurality of magnets 22, for example, permanent magnets, arranged on the outer circumferential surface thereof, and a hollow shaft 23 which rotates integrally with the rotor core 21 on the central axis of the motor 5. The hollow shaft 23 is rotatably arranged in the housing 12 via bearings 51, 52.

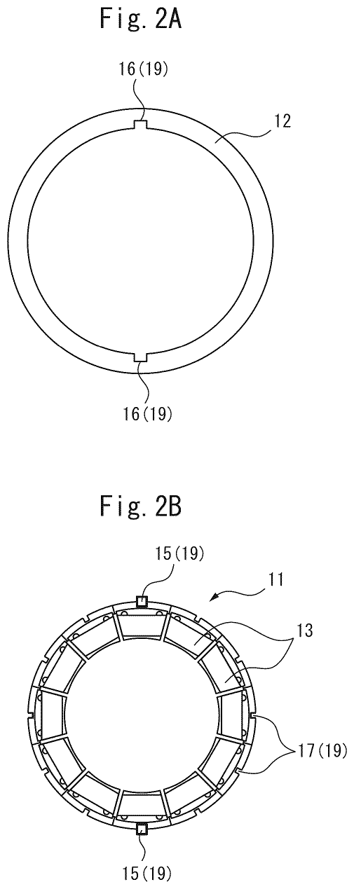

FIG. 2A is a radial cross-sectional view of a housing. As shown in FIG. 2A, a pair of keyways 16 are formed on the inner peripheral surface of the housing 12. These keyways 16 are formed at positions facing each other in the diametrical direction of the housing 12. The number of keyways 16 is preferably one or more. A plurality of keyways 16 may be formed at non-equidistant intervals in the circumferential direction of the housing 12.

FIG. 2B is a radial cross-sectional view of a stator core. As shown in FIG. 2B, a plurality of coils 13 are affixed at equal intervals on the inner peripheral surface side of the stator core 11. A plurality of grooves 17 are formed on the outer peripheral surface of the stator core 11 at positions corresponding to the central portions of the plurality of coils 13. Furthermore, parallel keys 15 extending parallel to the axial direction of the hollow shaft 23 are inserted into the pair of grooves 17 corresponding to each other in the diametrical direction of the stator core 11. The number of parallel keys 15 is preferably one or more, and in FIG. 2B, the parallel keys 15 are inserted into the pair of grooves 17 facing each other in the diametrical direction. However, the parallel keys 15 may be inserted into other grooves 17 located at positions corresponding to the keyways 16. Furthermore, the grooves 17 may be formed at positions different from the central portions of the coils 13, for example, at positions corresponding to the spaces between two adjacent coils 13.

The positions of one or more keyways 16 formed in the housing 12 are known in advance, and the positional relationship between the grooves 17 and the coils 13 is also known in advance. Thus, by inserting the one or more parallel keys 15 into the grooves 17 of the stator core 11 so as to engage with such keyways 16, it is possible to determine the relative angle between the plurality of coils 13 of the stator core 11 and the housing 12. Therefore, the one or more parallel keys 15, the one or more keyways 16, and the one or more grooves 17 serve as a first structure 19 for determining the relative angle between the plurality of coils 13 of the stator core 11 and the housing 12. Note that a similar effect can be obtained even when the parallel keys 15 and the grooves 17 are integrated and a part of the parallel keys 15 protrudes from the grooves 17 as a protrusion.

In general, the rotor core 21 and the hollow shaft 23 of the rotor 20 are separate members which are coupled to each other. However, in the first embodiment, as can be seen with reference to FIG. 1, the hollow shaft 23 and the rotor core 21 are integrally formed. Specifically, the hollow shaft 23 and the rotor core 21 are a single member.

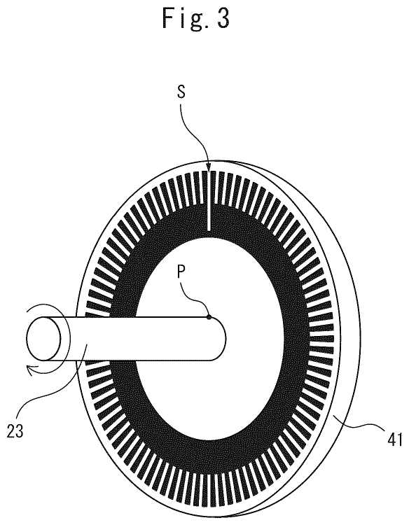

FIG. 3 is a perspective view showing the hollow shaft and the rotary disk. As shown in FIG. 3, in order to accurately detect the Z-phase with the rotary disk 41, a fixed reference position P for the rotary disk 41, for example, a mark, is formed on a part of the outer circumferential surface of the hollow shaft 23. The rotary disk 41 is attached to the hollow shaft 23 so that the fixed reference position P for the rotary disk and a Z-phase slit S formed in advance on the rotary disk 41 correspond to each other. Typically, the rotary disk 41 is attached to the hollow shaft 23 so that the circumferential position of the fixed reference position P for the rotary disk and the circumferential position of the Z-phase slit S match, as will be described later.

As described above, since the hollow shaft 23 and the rotor core 21 are integrally molded, the relative angle between the magnetic poles of the rotor core 21 and the fixed reference position P provided on the hollow shaft 23 is automatically and fixedly determined. Thus, the integrally-molded hollow shaft 23 and rotor core 21 serve as a second structure 29 for determining the positional relationship between the fixed reference position P for the rotary disk of the hollow shaft 23 and the magnetic poles of the magnet 22 mounted on the rotor core 21.

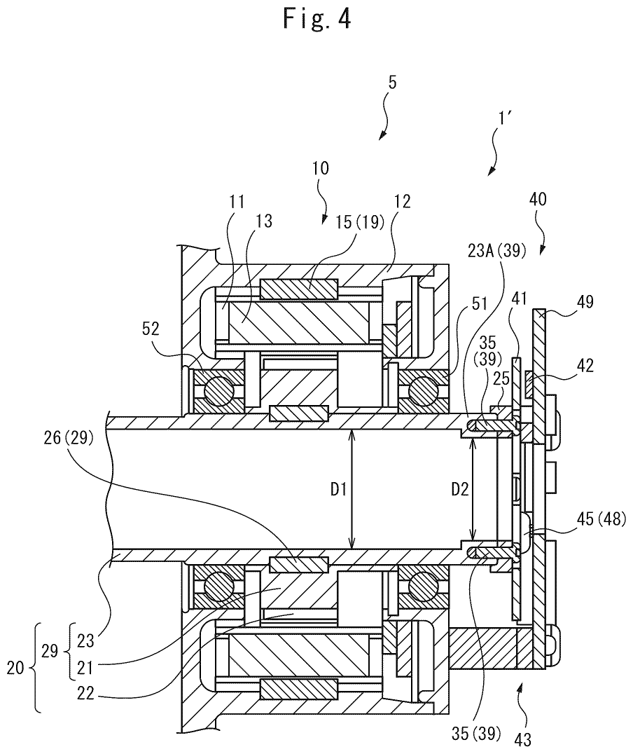

FIG. 4 is an axial cross-sectional view of an actuator detailing a modification example of the second structure. In the actuator 1′ shown in FIG. 4, the rotor core 21 and the hollow shaft 23 are separate members. One or more grooves (not illustrated) are formed each on the inner peripheral surface of the rotor core 21 and on the outer peripheral surface of the hollow shaft 23.

One or more parallel keys 26 extending parallel to the axial direction of the hollow shaft 23 mate with grooves in the rotor core 21 and the hollow shaft 23, whereby the rotor core 21 and the hollow shaft 23 are coupled to each other. The number and positions of the parallel keys 26 are similar to those of the parallel keys 15 described above.

Since the rotor core 21 and the hollow shaft 23 are coupled to each other by the parallel keys 26 and grooves, the relative angle between the magnetic poles of the rotor core 21 and the fixed reference position P provided on the hollow shaft 23 is automatically and fixedly determined. Thus, the grooves formed on the inner circumferential surface of the rotor core 21, the grooves formed on the outer circumferential surface of the hollow shaft 23, and the parallel keys 26 serve as the second structure 29 described above. Note that a similar effect can be obtained in the case where the parallel keys 26 and the corresponding grooves are integrated and a part of the parallel keys 26 protrudes from the grooves as a protrusion.

As shown in FIG. 1, the hollow shaft 23 comprises an extension 23A between the rotary disk 41 and the motor 5, the thickness of which increases toward the interior thereof in the radial direction of the hollow shaft 23. The extension 23A is formed at one end of the hollow shaft 23 on the encoder 40 side. Due to the presence of such an extension 23A, the inner diameter D1 of the hollow shaft 23 is larger than the inner diameter D2 of the extension 23A. In an embodiment, (D1-D2)/D1 is preferably 0.1 to 0.2. The length and thickness of the extension 23A in the axial direction of the hollow shaft 23 are large enough to receive a rotary disk fixed part 35, which will be described later.

In FIG. 1, the rotary disk 41 of the encoder 40 is affixed to the end surface of the extension 23A by a rotary disk fixed part 35. Typically, the rotary disk fixed part 35 is a combination of a plurality of first screws 35 extending parallel to the axial direction of the hollow shaft 23 and a plurality of holes formed in the end surface of the extension 23A so as to correspond to the plurality of first screws 35. However, other forms of the rotary disk fixed part 35 which are capable of affixation of the rotary disk 41 to the extension 23A may be adopted.

Thus, in the first embodiment, the rotary disk 41 of the encoder 40 can be easily connected to the end surface of the hollow shaft 23. Note that the number of the first screws 35 and the number of holes may be different, and the first screws 35 need not be arranged at equal intervals in the circumferential direction of the hollow shaft 23.

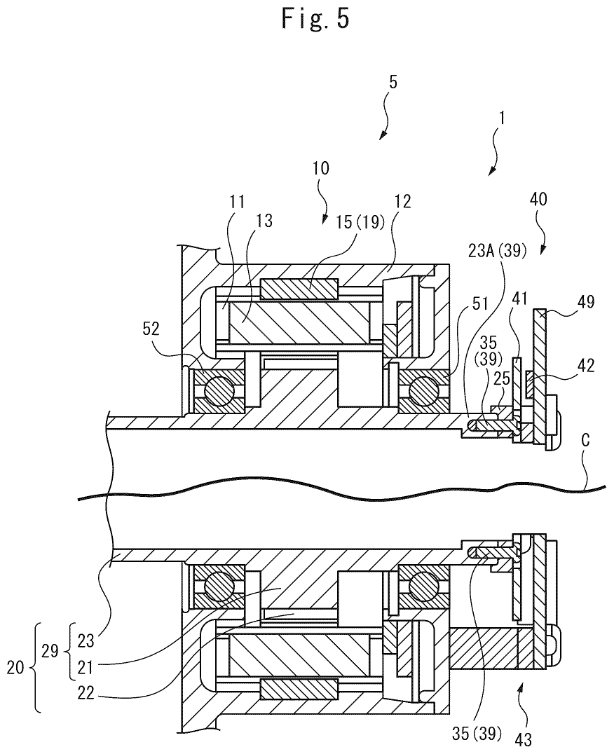

FIG. 5 is another axial cross-sectional view of the actuator shown in FIG. 1. In FIG. 5, at least one filamentary body C, such as a cable or a pipe for supplying power, a signal, or a material, passes through the actuator 1 through the internal space of the hollow shaft 23. The at least one filamentary body C is affixed by affixation parts (not illustrated in FIGS. 1 and 5) near both ends of the actuator 1.

As can be seen from FIGS. 1 and 5, the thickness of the extension 23A is sufficiently smaller than the inner diameter of the hollow shaft 23. Thus, even if the extension 23A is formed, there is no need to reduce the number of filamentary bodies C, and the slack of these filamentary bodies C can be maintained.

Strictly speaking, in FIGS. 1 and 5, the rotary disk 41 is affixed to the end surface of the extension 23A via a boss 25 by a plurality of first screws 35. It is preferable that the boss 25 be attached to the rotary disk 41 via adhesive or the like. The rotary disk 41 may be directly affixed to the end surface of the extension 23A. In this case, the rotary disk 41 of the encoder can be more easily connected to the hollow shaft 23. It should be understood that the extension 23A, the holes formed in the extension 23A, and the first screw 35 serve as a third structure 39 for determining the relative angle between the hollow shaft 23 and the rotary disk 41.

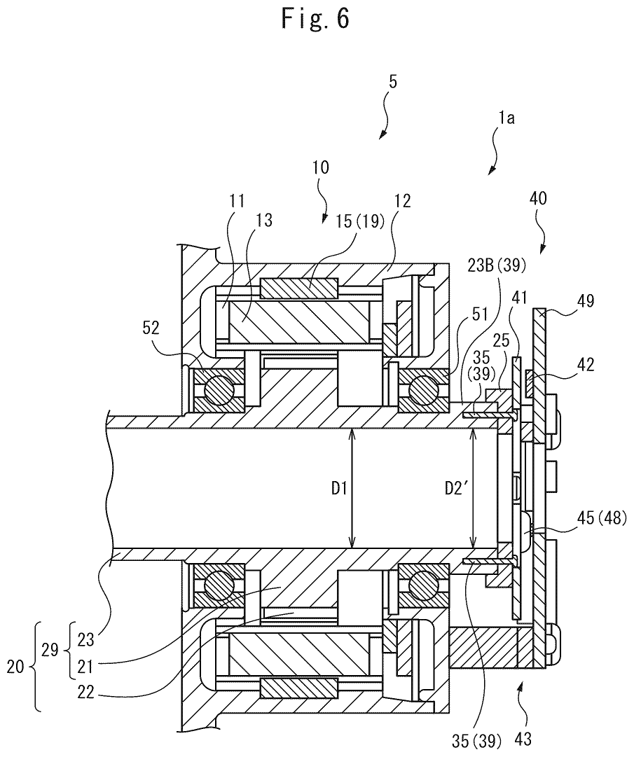

FIG. 6 is an axial cross-sectional view of an actuator according to another embodiment. The actuator 1a in this other embodiment includes an extension 23B, which increases in thickness toward the radially outward direction of the hollow shaft 23 between the rotary disk 41 and the motor 5, instead of the extension 23A. As shown in FIG. 6, the inner diameter D1 of the hollow shaft 23 is equal to the inner diameter D2′ of the extension 23B. In other words, even if the extension 23B is formed, the inner diameter of the hollow shaft 23 does not change throughout the entire hollow shaft 23. The rotary disk 41 of the encoder 40 is affixed to the end surface of the extension 23B by a plurality of first screws 35 extending parallel to the axial direction of the hollow shaft 23.

In this case, since the inside diameter of the extension 23B is equal to the inside diameter of the other portion of the hollow shaft 23, one or more filamentary bodies C can pass through the hollow shaft 23 with more leeway than in the embodiment shown in FIG. 1. Further, as described above, the scope of the present disclosure also includes the case in which the rotary disk 41 is affixed directly to the end surface of the extension 23B without the boss 25. Furthermore, the scope of the present disclosure also includes the case in which both the extension 23A and the extension 23B are formed on one end of the hollow shaft 23.

Referring to FIG. 1, a detection unit 42 provided on a substrate 49 of the encoder 40 detects, by a known method, an absolute position PA1 within one rotation and a total number of rotations PB1 of the hollow shaft 23. The detected information is stored in a memory (not illustrated), for example, a volatile memory.

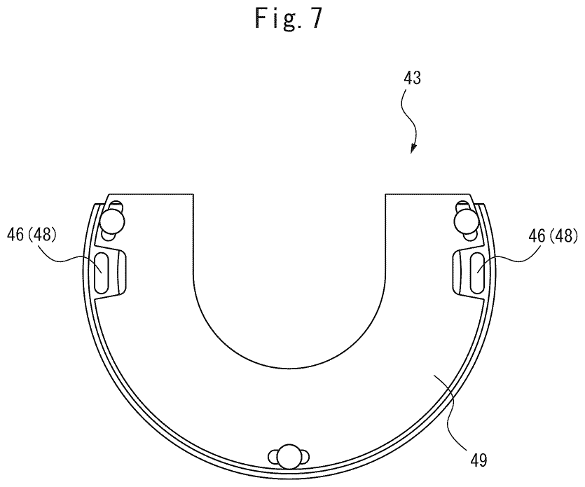

FIG. 7 is a front view of an encoder fixed part. As can be understood from FIGS. 1 and 7, a plurality of slots 46 are formed in the substrate 49 of the encoder fixed part 43 of the encoder 40.

The portion of each slot 46 that extends in the circumferential direction of the hollow shaft 23 is longer than the portion that extends in the radial direction of the hollow shaft 23. A typical slot 46 is oval or elliptical, but may be of other shapes.

A plurality of second screws 45 are inserted into the plurality of slots 46 of the substrate 49 and affixed to the housing 12. For this purpose, holes for the plurality of second screws 45 are formed in the housing 12. It is preferable that the second screws 45 extend parallel to the axial direction of the hollow shaft 23. Since the slots 46 are not circular, after the second screws 45 are screwed in, the position of the encoder fixed part 43 can be finely adjusted in the circumferential direction within the range of the circumferential lengths of the slots 46.

Since the detection unit 42 is in a predetermined position relative to the fixed part 43 of the encoder 40, the detection unit 42 can be arranged at a desired position relative to the housing 12. Thus, the second screws 45 and slots 46, as well as the holes in the housing 12, define a relative angle between the housing 12 and the detection unit 42 and serve as a fourth structure 48 for adjusting the relative angle. The fourth structure 48 allows room for adjusting the position of the detection unit 42 in the rotational direction after the encoder 40 is attached.

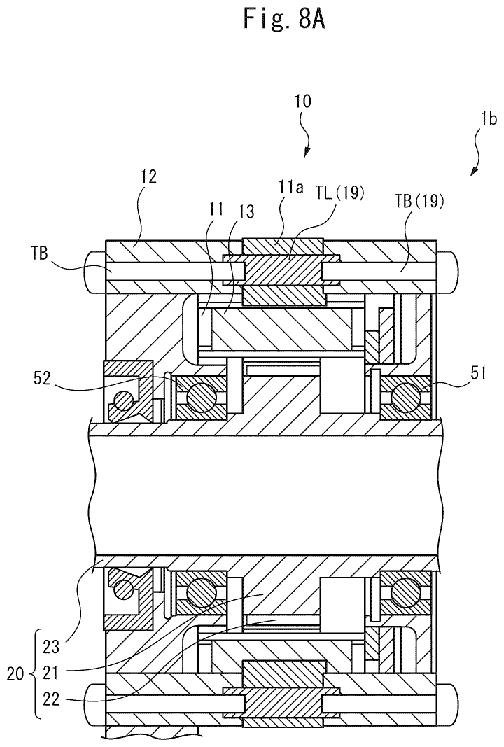

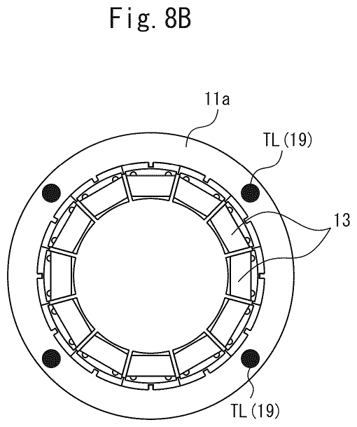

FIG. 8A is a partial axial cross-sectional view of an actuator according to another embodiment, and FIG. 8B is a radial cross-sectional view of the actuator shown in FIG. 8A. For the sake of simplicity, the encoder 40 has been omitted from FIG. 8A. A housing 12 of the actuator 1b shown in FIG. 8A has a plurality of through holes formed parallel to the axial direction of the hollow shaft 23. The stator core 11 has a flange 11a that extends outwardly in the radial direction of the hollow shaft 23 to the outer circumferential surface of the housing 12.

As shown in FIG. 8A, the flange 11a is configured so as to engage with a notched portion of the housing 12. In other words, the flange 11a is interposed between the housing 12 from the upstream side and the downstream side in the axial direction of the hollow shaft 23.

The flange 11a of the stator core 11 also has a plurality of through holes corresponding to the through holes of the housing 12 formed therein. In other words, the plurality of through holes of the flange 11a communicate with the respective plurality of through holes of the housing 12.

A tie rod TL is positioned in each through hole of the flange 11 a. The length of the tie rod TL is longer than the length of the flange 11a in the axial direction of the hollow shaft 23, and shorter than the length of the housing 12 in the axial direction of the hollow shaft 23. Thus, both ends of each tie rod TL do not reach both ends of the housing 12 in the axial direction of the hollow shaft 23.

As can be understood from FIG. 8B, the plurality of tie rods TL are arranged at equal intervals in the circumferential direction of the hollow shaft 23. However, the plurality of tie rods TL may be arranged at non-equidistant intervals in the circumferential direction of the hollow shaft 23.

Further, as shown in FIG. 8A, a plurality of tie bolts TB are inserted into the through holes from both ends of the housing 12 in the axial direction of the hollow shaft 23, and are coupled to each of the tie rods TL. For this purpose, it is preferable that both ends of each of the tie rods TL have female threading. In this manner, the plurality of tie bolts TB and the plurality of tie rods TL secure the housing 12 and the stator core 11 together.

Thus, the relative angle between the coils 13 of the stator core 11 and the housing 12 is fixedly determined. In other words, the flange 11a, the tie rods TL, and the tie bolts TB serve as the first structure 19. Note that the tie rods TL may not be present, and the tie bolts TB may be configured so as to screw into threading formed in the through holes of the flange 11a and the inner surface of the through holes of the housing 12.

Furthermore, in an unillustrated embodiment, a plurality of tie rods TL which are longer than the length of the housing 12 in the axial direction of the hollow shaft 23 and which have male threading formed on both ends thereof may be used. In this case, the male threading portions of the plurality of tie rods TL protrude from both ends of the through hole, and nuts are screwed onto the male threading portions instead of the tie bolts TB.

Alternatively, in another unillustrated embodiment, the tie rods TL may be eliminated, and a plurality of bolts which are longer than the length of the housing 12 in the axial direction of the hollow shaft 23 may be used. The bolts are then screwed into female threading formed in advance in the through holes of the flange 11a and the housing 12.

In these unillustrated embodiments, the relative angle between the coils 13 of the stator core 11 and the housing 12 can be fixedly determined in the same manner as described above. Thus, the nuts and bolts also serve as the first structure 19.

As described above, in the present disclosure, the relative angle between the plurality of coils 13 of the stator core 11 and the housing 12 is determined by the first structure 19, the relative angle between the magnetic poles of the rotor core 21 and the fixed reference position of the rotary disk 41 provided on the shaft 23 is determined by the second structure 29, the relative angle between the shaft 23 and the rotary disk 41 is determined by the third structure 39, and the relative angle between the housing 12 and the detection unit 42 is determined and can be adjusted by the fourth structure 48. Therefore, the angle of the Z phase of the encoder unit can be accurately adjusted.

### Aspects of the Present Disclosure

According to a first aspect, there is provided an actuator comprising a stator, wherein the stator includes a housing, and a stator core which is affixed in the housing and around which a plurality of coils are wound, the actuator further comprising a rotor which is arranged so as to face the stator, wherein the rotor includes a rotor core for forming a plurality of magnetic poles, and a shaft which is coupled to the rotor core, the actuator further comprising an encoder unit, wherein the encoder unit includes a rotary disk which is connected to the shaft, a detection unit for detecting rotation of the rotary disk, and a fixed part which is affixed in the housing, the actuator further comprising a first structure for determining a relative angle between the plurality of coils of the stator core and the housing, a second structure for determining a relative angle between the magnetic poles of the rotor core and a fixed reference position of the rotary disk provided on the shaft, a third structure for determining a relative angle between the shaft and the rotary disk, and a fourth structure for determining and adjusting a relative angle between the housing and the detection unit.

According to a second aspect, in the first aspect, the third structure includes a plurality of first screws for affixation of a boss attached to the rotary disk or the rotary disk and the shaft, and a plurality of screw holes formed in the shaft for engaging with the first screws.

According to a third aspect, in the first or second aspect, the fourth structure includes a plurality of slots formed in the fixed part of the encoder unit, and a plurality of second screws which are inserted into the respective slots.

According to a fourth aspect, in any of the first through third aspects, the first structure includes a plurality of keyways formed in the stator core and the housing, and a plurality of parallel keys for engaging with the respective keyways.

According to a fifth aspect, in any one of the first through third aspects, the first structure includes a plurality of keyways formed in one of the housing and the stator core, and a plurality of protrusions provided in the other of the housing and the stator core for engaging with the respective keyways.

According to a sixth aspect, in the first aspect, the first structure includes a flange provided on the stator core and engaging with the housing, a plurality of through holes formed in the housing and the flange and communicating with each other, and a plurality of tie bolts screwed into the plurality of through holes.

According to a seventh aspect, in any of the first through sixth aspects, the second structure includes a plurality of keyways formed in the rotor core and the shaft, and a plurality of parallel keys which engage with the respective plurality of keyways.

According to an eighth aspect, in any of the first through sixth aspects, the second structure includes a plurality of keyways formed in one of the rotor core and the shaft, and a plurality of protrusions provided on the other of the rotor core and the shaft and engaging with each of the plurality of keyways.

According to a ninth aspect, in any of the first through sixth aspects, the rotor core and the shaft are integrally formed in the second structure.

According to a tenth aspect, in any of the first through ninth aspects, the encoder is an optical encoder or a magnetic encoder.

### Effects of the Aspects

In the first aspect, the Z-phase angle of the encoder unit can be accurately adjusted.

In the second aspect, the relative angle between the shaft and the rotary disk can be fixedly determined.

In the third aspect, the relative angle between the housing and the detection unit is determined, and the relative angle is adjusted after the encoder is installed.

In the fourth aspect, the relative angle between the plurality of coils of the stator core and the housing can be fixedly determined.

In the fifth aspect, the relative angle between the plurality of coils of the stator core and the housing can be fixedly determined.

In the sixth aspect, the relative angle between the plurality of coils of the stator core and the housing can be fixedly determined.

In the seventh aspect, the angle between the magnetic poles of the rotor core and the shaft can be fixedly determined.

In the eighth aspect, the angle between the magnetic poles of the rotor core and the shaft can be fixedly determined.

In the ninth aspect, the second structure can be easily constructed.

Though the embodiments of the present disclosure have been described in detail, the present disclosure is not limited to the individual embodiments described above. Various additions, replacements, modifications, or partial deletions can be made to these embodiments within the scope of the spirit of the invention, or within the scope of the idea and intent of the present invention derived from the contents described in the claims and their equivalents. For example, the order of each operation and the order of each process of the embodiments described above are shown as examples, and are not limited to these. The same applies when numerical values or formulas are used in the description of the embodiments described above. Furthermore, appropriate combinations of some of the embodiments described above are included in the scope of the present disclosure.

### REFERENCE SIGNS LIST

1, 1a actuator
5 motor
10 stator
11 stator core
11a flange
12 housing
13 coil
15 parallel key
19 first structure
20 rotor
21 rotor core
22 magnet
23 hollow shaft
23A, 23B extension
25 boss
26 parallel key
29 second structure
30 speed reducer
31 low-speed tube
32 output shaft
35 first screw
39 third structure
40 encoder
41 rotary disk
42 detection unit
43 encoder fixed part
46 slot
48 fourth structure
49 substrate
51, 52 bearing
61,62 fixed part
C filamentary body
P fixed reference position
S Z-phase slit
TL tie rod
TB tie bolt

1. An actuator, comprising:
a stator, wherein
the stator includes a housing, and a stator core which is affixed in the housing and around which a plurality of coils are wound, the actuator further comprising:
a rotor which is arranged so as to face the stator, wherein
the rotor includes a rotor core for forming a plurality of magnetic poles, and a shaft which is coupled to the rotor core, the actuator further comprising:
an encoder unit, wherein
the encoder unit includes a rotary disk which is connected to the shaft, a detection unit for detecting rotation of the rotary disk, and a fixed part which is affixed in the housing, the actuator further comprising:
a first structure for determining a relative angle between the plurality of coils of the stator core and the housing,
a second structure for determining a relative angle between the magnetic poles of the rotor core and a fixed reference position of the rotary disk provided on the shaft,
a third structure for determining a relative angle between the shaft and the rotary disk, and
a fourth structure for determining and adjusting a relative angle between the housing and the detection unit.

2. The actuator according to claim 1, wherein the third structure includes a plurality of first screws for affixation of a boss attached to the rotary disk or the rotary disk and the shaft, and a plurality of screw holes formed in the shaft for engaging with the first screws.

3. The actuator according to claim 1, wherein the fourth structure includes a plurality of slots formed in the fixed part of the encoder unit, and a plurality of second screws which are inserted into the respective slots.

4. The actuator according to claim 1, wherein the first structure includes a plurality of keyways formed in the stator core and the housing, and a plurality of parallel keys for engaging with the respective keyways.

5. The actuator according to 1, wherein the first structure includes a plurality of keyways formed in one of the housing and the stator core, and a plurality of protrusions provided in the other of the housing and the stator core for engaging with the respective keyways.

6. The actuator according to claim 1, wherein the first structure includes a flange provided on the stator core and engaging with the housing, a plurality of through holes formed in the housing and the flange and communicating with each other, and a plurality of tie bolts screwed into the plurality of through holes.

7. The actuator according to claim 1, wherein the second structure includes a plurality of keyways formed in the rotor core and the shaft, and a plurality of parallel keys which engage with the respective plurality of keyways.

8. The actuator according to claim 1, wherein the second structure includes a plurality of keyways formed in one of the rotor core and the shaft, and a plurality of protrusions provided on the other of the rotor core and the shaft and engaging with each of the plurality of keyways.

9. The actuator according to claim 1, wherein the rotor core and the shaft are integrally formed in the second structure.

10. The actuator according to claim 1, wherein the encoder is an optical encoder or a magnetic encoder.
